(19) United States
(12) Patent Application Publication
(10) Pub. No.: US 2018/0364081 A1
(43) Pub. Date: Dec. 20, 2018

(54) MAGNETO-INDUCTIVE FLOW MEASURING DEVICE

(71) Applicant: Endress+Hauser Flowtec AG, Reinach (CH)

(72) Inventors: Nikolai Fink, Aesch (CH); Frank Schmalzried, Zolling (DE); Heinz Rufer, Dornach (CH); Wolfgang Drahm, Erding (DE)

(21) Appl. No.: 16/061,269

(22) PCT Filed: Nov. 15, 2016
(86) PCT No.: PCT/EP2016/077699

§ 371 Date: Jun. 11, 2018

(30) Foreign Application Priority Data
Dec. 14, 2015 (DE) 10 2015 121 730.9

(51) Int. Cl. G01F 1/58; G01F 1/60

(52) U.S. Cl. CPC G01F 1/588; G01F 1/60

(57) ABSTRACT

The invention relates to a magneto-inductive flow measuring device for measuring flow velocity or volume flow of a medium in a pipeline as well as to a method for implementing the magneto-inductive flow measuring device. In such case, the remanent magnetic field of at least one permanent magnet is applied for flow monitoring and flow measurement, wherein the flow measurement is performed upon achievement of criteria.

The invention relates to a magneto-inductive flow measuring device for measuring flow velocity or volume flow, i.e. volume flow rate or total volume flow, of a medium flowing in a pipeline as well as to a method for implementing the magneto-inductive flow measuring device.

The fundamental principle of magneto-inductive flow measuring devices has been known for a long time. In such case, a conductive medium, which is flowing through a measuring tube, is subjected to a magnetic field, whereby an electrical voltage is induced in the medium. This electrical voltage is ideally proportional to the strength of the magnetic field and to the flow velocity of the medium. By measuring the voltage, conclusions can be drawn concerning the flow velocity, or the volume flow, as the case may be. Further developments of such flow measuring devices concern, among other things, improvements of signal quality, lessening of energy consumption or lessening of manufacturing costs. The unpublished patent application DE 102015103580.4 describes a magneto-inductive flow measuring device, wherein the flow measuring device has a first magnet system having at least one coil with a magnetic coil core and a second magnet system having at least one permanent magnet. The permanent magnet system is adapted to produce a permanent magnetic field for monitoring the flow of a medium. In the case of a defined flow change, the first magnet system is brought into play, in order to measure the flow with high accuracy. By applying the first magnet system only in case necessary, energy can be saved. However, this flow measuring device has the disadvantage that the cost of materials is increased by needing both a coil core and a permanent magnet. Moreover, the arrangement of the first magnet system and the second magnet system presents difficulties. Either the magnetic fields of the first magnet system and the second magnet system are superimposed, in order to achieve a compact construction, or the two systems are installed inclined relative to one another. The first option has the advantage of a compact arrangement on the measuring tube, but has, however, the disadvantage that the total magnetic field applied for measuring oscillates not about a zero-point, but, instead, about the static magnetic field defined by the permanent magnet. The latter has the advantage of a greater independence of the magnet systems from one another, however, a second electrode pair is required and the arrangement of the magnet systems is connected with greater spatial expansion.

Objects of the present invention are, consequently, to provide a magneto-inductive flow measuring device having flow monitoring and to provide an easy and robust method for operating the flow measuring device, wherein the measuring and the monitoring of the flow is implemented by a single magnet system. The objects of the invention are achieved by an apparatus as claimed in independent claim 1 and by a method as claimed in independent claim 6.

The flow measuring device of the invention for measuring flow velocity or volume flow of a medium in a pipeline includes, in such case, a measuring tube; at least one magnet system, which is arranged on the measuring tube and which has at least one coil, which coil is adapted to produce a magnetic field, whose polarity is selectable and which can be switched on and off; and at least one pair of measuring electrodes;

wherein the magnet system further has at least one permanent magnet, which is adapted to produce a remanent magnetic field, which magnetic field is oriented in the measuring tube essentially transversely to the longitudinal axis of the measuring tube,

wherein the coil is adapted to set strength and/or direction of the remanent magnetic field,

wherein the remanent magnetic field is the magnetic field of the permanent magnet remaining after turning off of the magnetic field produced by the coil,

wherein the pair of measuring electrodes is adapted to tap the electrical measurement voltage induced by the remanent magnetic field,

wherein the flow measuring device has at least one electronic operating circuit, which is adapted to monitor or to measure the measurement voltage tapped by the pair of measuring electrodes,

wherein the operating circuit has at least two operating modes,

wherein a first operating mode includes a monitoring of flow velocity or volume flow of a medium by monitoring the tapped measurement voltage, wherein a second operating mode includes a measuring of flow velocity or volume flow of the medium by measuring and evaluating a first measurement voltage and a second measurement voltage, which measurement voltages are induced by two different remanent magnetic fields,

wherein the operating circuit is further adapted, after the achievement of a test criterion, to change from the first operating mode into the second operating mode.

Preferably selected for producing a remanent magnetic field is a material, whose magnetization only slightly softens after turning off external magnetic fields.

In an embodiment of the flow measuring device, the test criterion for changing from the first into the second operating mode is at least one of the following criteria:

minimum rate of change of the measurement voltage,

minimum change of the measurement voltage,

expiration of a time interval.

In an embodiment of the flow measuring device, at least one of the criteria is adaptable. Thus, for example, measurement voltage as a function of time can be taken into consideration as basis for adapting at least one of the criteria.

In an embodiment of the flow measuring device, the operating circuit is adapted in the second operating mode to perform a number of measurements of flow velocity or volume flow of the medium, wherein the criterion for changing from the second into the first operating mode is at least one of the following criteria:

change of the ascertained flow to lower than a minimum flow-limit value MV over at least two measurements,

reaching an established number of measurements n.

In an embodiment of the flow measuring device, at least one criterion for changing from the second operating mode into the first operating mode is adaptable.

In an embodiment of the flow measuring device, the magnet system includes, furthermore, at least one guide material, which is adapted to guide the remanent magnetic field from the magnet system to the measuring tube. This embodiment has the advantage that only a coil and a permanent magnet are necessary for producing an almost homogeneous magnetic field in the measuring tube. In this way, material costs and complexity of the flow measuring device can be further reduced.

In an embodiment of the flow measuring device, after changing from the first operating mode into the second operating mode and before measuring the first measurement voltage (M1), the strength and/or direction of the remanent magnetic field is reset. In this way, the accuracy of measurement, especially of the measuring of the first measurement voltage, can be increased.

A method of the invention for implementing the flow measuring device of the invention includes steps as follows:

applying the first operating mode for monitoring the flow velocity or volume flow of the medium;

upon achieving at least one of the criteria

1. Minimum rate of change of the measurement voltage,

2. Minimum change of the measurement voltage,

3. Expiration of a time interval,

changing into the second operating mode for measuring flow velocity or volume flow of the medium;

after ending measuring flow velocity or volume flow of the medium, changing into the first operating mode.

The present invention thus provides a magneto-inductive flow measuring device as well as a method for operating the flow measuring device.

The invention will now be explained in greater detail based on the appended drawing, the figures of which show as follows:

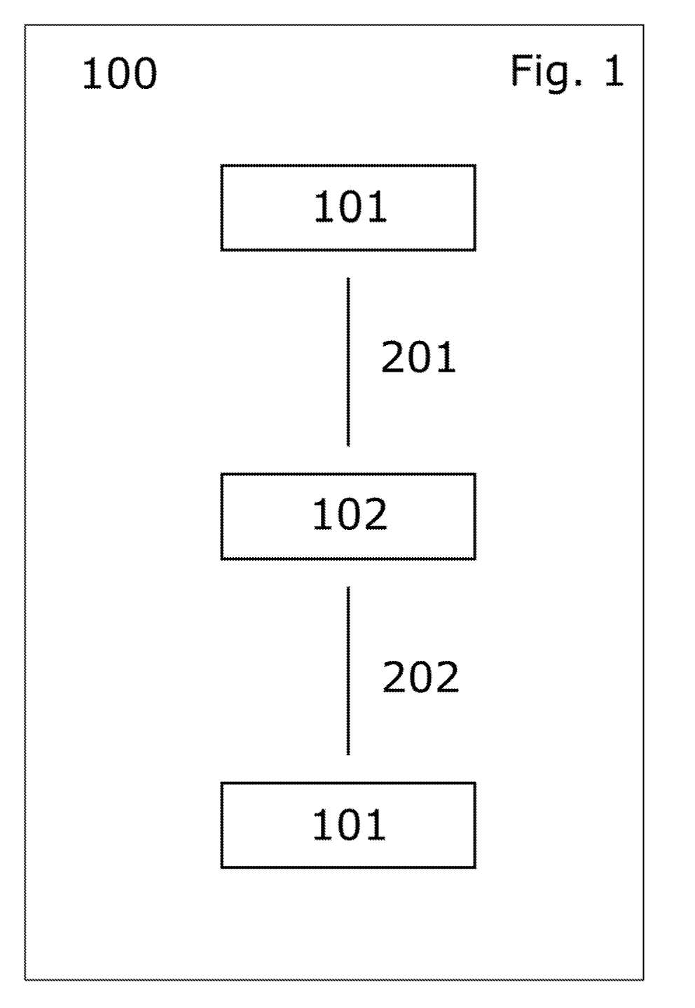

FIG. 1 an example of a flow diagram for implementing a method for operating a flow measuring device;

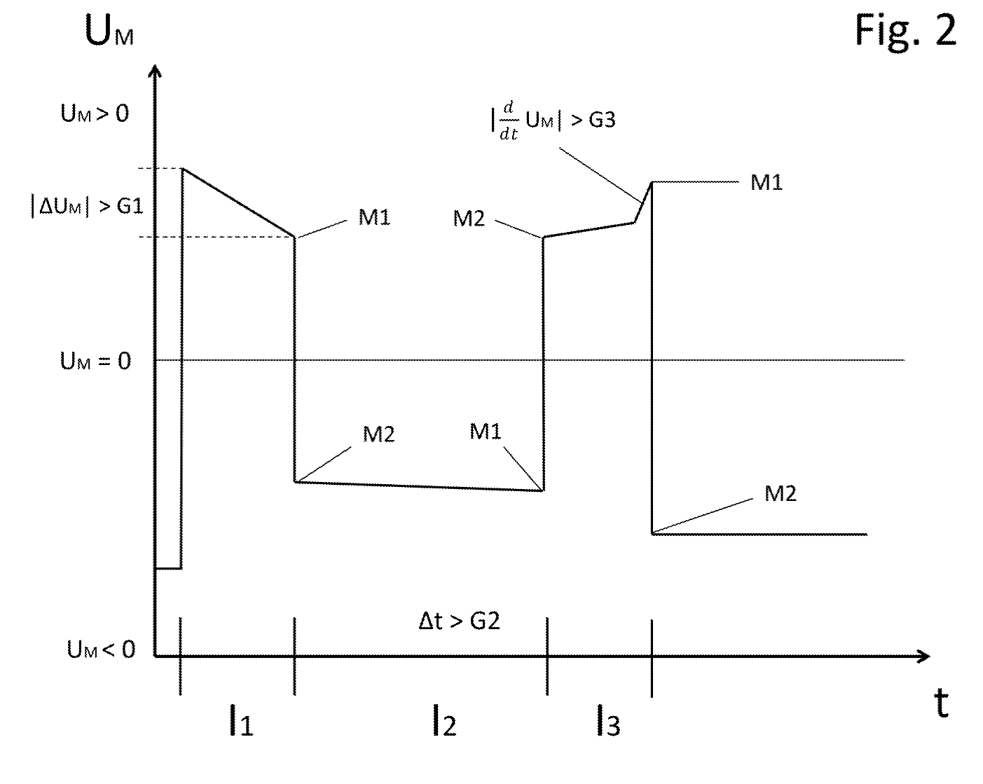

FIG. 2 an example of electrode voltage as a function of time as measured by the flow measuring device;

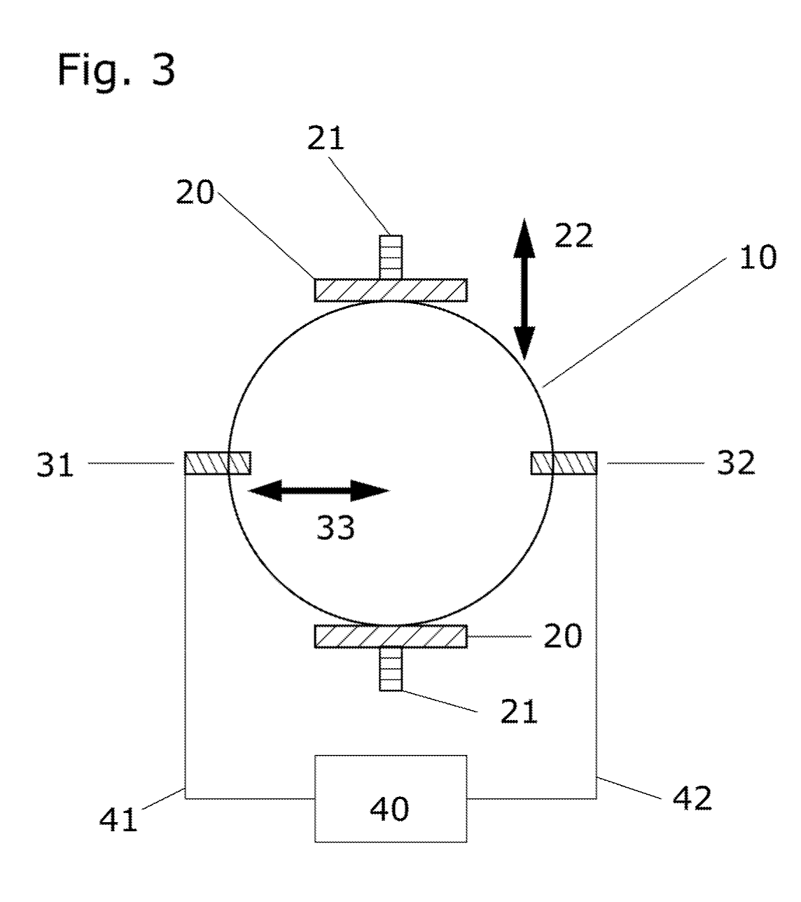

FIG. 3 an example of a magneto-inductive flow measuring device in a cross section; and

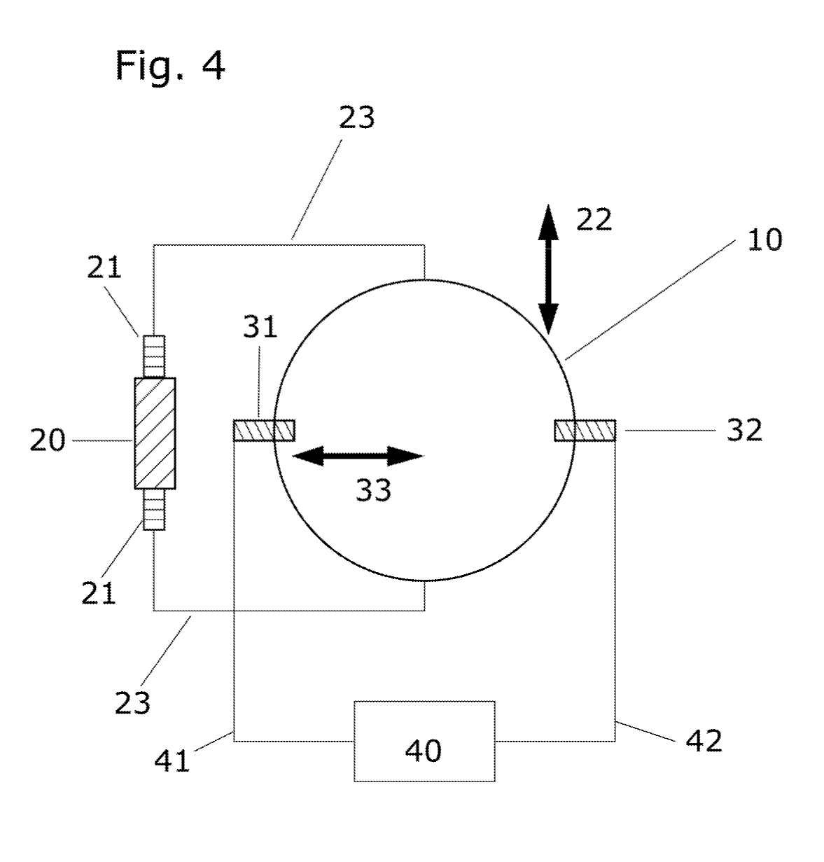

FIG. 4 a further example of a magneto-inductive flow measuring device in a cross section.

FIG. 1 shows a flow diagram, in which the essential steps of a method 100 for operating a flow measuring device are illustrated. First, the flow measuring device is located in a first operating mode 101, wherein the first operating mode includes a monitoring of flow velocity or volume flow of a medium by monitoring the tapped measurement voltage Um. Upon achieving 201 a test criterion, the operating circuit causes the flow measuring device to change from the first operating mode 101 into a second operating mode 102, wherein the second operating mode 102 includes a measuring of flow velocity or volume flow of the medium by measuring and evaluating two measurement voltages in the case of different remanent magnetic fields. After ending 202 the measuring of two measurement voltages, the flow measuring device is then caused to change from the second operating mode 102 into the first operating mode 101.

FIG. 2 shows as a function of time an example of measurement voltage U_{M} measured by an electrode pair. The graph shows three monitoring intervals, in which the flow measuring device is located in the operating mode 101 and the measurement voltage U_{M} is monitored. After achieving a criterion 201, which criterion can be, for example, a minimum change of the measurement voltage U_{M} or a minimum duration of an interval or a minimum rate of change of the measurement voltage, the flow measuring device transfers from the operating mode 101 into the operating mode 102 and conducts a measuring of flow velocity or volume flow of the medium by measuring and evaluating two measurement voltages at different remanent magnetic fields. For example, there occurs in the monitoring interval I1 the fulfillment 201 of at least one criterion for changing from the first into the second operating mode as a result of a minimum change of the measurement voltage, wherein the minimum change is greater than G1. As a result, the flow measuring device transfers into the operating mode 102 and measures two measurement voltages M1 and M2. After ending 202 of the measuring, the flow measuring device transfers back into the first operating mode. In this example, the duration of the flow measurement in the second operating mode is short compared with the duration of the monitoring of the measurement voltage in the first operating mode, so that the measuring mode 102 is shown by vertical lines. Thus, there happens in the monitoring interval I1 an exceeding of a minimum change of the measurement voltage, wherein the change is greater than a voltage value G1. Thereupon, a flow measurement is performed by measuring two measured voltage values M1 and M2, in order then to start the following monitoring interval I2. During the monitoring interval I2, a monitoring interval greatest duration G2 is exceeded, wherein, with the exceeding of G2, the monitoring mode is left and the measuring mode entered, in order to perform anew a flow measurement by measuring two measurement voltages M1 and M2. In the following monitoring mode I3, an exceeding of a greatest rate of change of the measurement voltage occurs, wherein the time rate of change of the measurement voltage is greater than a value G3, this meaning, thus, the fulfilling of a further criterion for changing from the operating mode 101 into the operating mode 102.

In an advantageous embodiment, after changing from the first operating mode into the second operating mode and before measuring the measurement voltage M1, firstly, the remanent magnetic field is reverse poled, in order then to continue with the measuring of two measurement voltages M1 and M2.

FIG. 3 shows a cross-section through the measuring tube 10 of a flow measuring device, wherein located in the cross-section are two coils 20 and two permanent magnets 21 of a magnet system as well as a measuring electrode pair composed of the measuring electrodes 31 and 32. The magnet system serves for producing a remanent magnetic field in the direction shown by arrow 22, which leads to a flow dependent, induced measurement voltage in the direction shown by arrow 33. The measurement voltage is tapped by the measuring electrode pair and fed through the lines 41, 42 to the operating circuit 40. The operating circuit is adapted to monitor and to measure the measurement voltage. If the operating circuit detects the necessity for a change of the magnetic field strength or the magnetic field direction relative to the pair of measuring electrodes 31, 32 by achieving 201 a criterion, the magnetic field of the permanent magnets 21 is changed by a magnetic field pulse from the coils 20 associated with the permanent magnets.

FIG. 4 shows a cross-section of a further example of an embodiment of a flow measuring device of the invention. In such case, the magnet system is not located on the measuring tube and the remanent magnetic field produced by the magnet system is guided to the measuring tube by a magnetically conductive guide material 23, so that the magnetic field is oriented in the measuring tube 10 essentially transversely to the longitudinal axis of the measuring tube.

### LIST OF REFERENCE CHARACTERS

10 measuring tube
20 coil
21 permanent magnet
22 direction of the produced magnetic field
23 guide material
30 measuring electrode pair
31, 32 measuring electrodes
33 direction of the induced measurement voltage
40 operating circuit
41, 42 lines between measuring electrodes and operating circuit
Uₘ measurement voltage
I_{n, n={1,2,3}} monitoring interval
100 method for operating the flow measuring device
101 first operating mode
102 second operating mode
201 fulfillment of at least one criterion for changing from 101 to 102
G1 maximum value of the change of measurement voltage
G2 maximum value of the interval duration
G3 maximum value of the rate of change of the measurement voltage
MV minimum flow

1-8. (canceled)

9. A magneto-inductive flow measuring device for measuring flow velocity or volume flow of a medium in a pipeline, comprising:
a measuring tube having a longitudinal axis;
at least one magnet system including at least one coil adapted to generate a magnetic field that can be switched on and off and including at least one permanent magnet adapted to produce in the measuring tube a remanent magnetic field that is oriented in the measuring tube substantially transversely to the longitudinal axis, wherein the at least one coil is adapted to change strength and/or direction of the remanent magnetic field, wherein the remanent magnetic field is a magnetic field of the at least one permanent magnet remaining after turning off the magnetic field generated by the coil;
at least one pair of measuring electrodes adapted to tap an electrical measurement voltage induced in the medium by the remanent magnetic field; and
an electronic operating circuit configured to monitor and/or to measure the measurement voltage tapped by the pair of measuring electrodes, the operating circuit having a first operating mode that includes monitoring a flow velocity or a volume flow of the medium by monitoring the tapped measurement voltage and having a second operating mode that includes at least one measuring of the flow velocity or the volume flow of the medium by measuring and evaluating a first measurement voltage and a second measurement voltage,
wherein the first measurement voltage and the second measurement voltage are induced by two different remanent magnetic fields, and wherein the operating circuit is further configured to change from the first operating mode to the second operating mode depending on a test criterion.

10. The flow measuring device of claim 9, wherein the test criterion for changing from the first operating mode to the second operating mode is at least one of the following criteria: a minimum rate of change of the measurement voltage, a minimum change of the measurement voltage, and/or an expiration of a time interval.

11. The flow measuring device of claim 10, wherein at least one of the criteria is adaptable.

12. The flow measuring device of claim 9, wherein the operating circuit is configured in the second operating mode to perform a plurality of measurements of the flow velocity or the volume flow of the medium, and wherein the test criterion for changing from the second operating mode to the first operating mode is at least one of the following criteria: a change of the ascertained flow velocity or volume flow below a minimum value over at least two measurements, and/or performing an established number of measurements.

13. The flow measuring device of claim 12, wherein at least one criteria for changing from the second operating mode to the first operating mode is adaptable.

14. The flow measuring device of claim 9, wherein the at least one magnet system further includes at least one guide material structured to guide the remanent magnetic field from the at least one magnet system to the measuring tube.

15. The flow measuring device of claim 9, wherein, after changing from the first operating mode to the second operating mode and before measuring the first measurement voltage, the strength and/or the direction of the remanent magnetic field is reset.

16. A method for measuring flow velocity or volume flow of a medium in a pipeline, the method comprising:
providing a magneto-inductive flow measuring device embodied to measure flow velocity or volume flow of the medium, the flow measuring device including:
a measuring tube having a longitudinal axis;
at least one magnet system including at least one coil adapted to generate a magnetic field that can be switched on and off and including at least one permanent magnet adapted to produce in the measuring tube a remanent magnetic field that is oriented in the measuring tube substantially transversely to the longitudinal axis, wherein the at least one coil is adapted to change strength and/or direction of the remanent magnetic field, wherein the remanent magnetic field is a magnetic field of the at least one permanent magnet remaining after turning off the magnetic field generated by the coil;
at least one pair of measuring electrodes adapted to tap an electrical measurement voltage induced in the medium by the remanent magnetic field; and
an electronic operating circuit configured to monitor and/or to measure the measurement voltage tapped by the pair of measuring electrodes, the operating circuit having a first operating mode that includes monitoring a flow velocity or a volume flow of the medium by monitoring the tapped measurement voltage and having a second operating mode that includes at least one measuring of the flow velocity or the volume flow of the medium by measuring and evaluating a first measurement voltage and a second measurement voltage,
wherein the first measurement voltage and the second measurement voltage are induced by two different remanent magnetic fields, and wherein the operating circuit is further configured to change from the first operating mode to the second operating mode depending on a test criterion;
applying the first operating mode of monitoring the flow velocity or the volume flow of the medium;
changing to the second operating mode of measuring flow velocity or volume flow of the medium upon meeting at least one of the following criteria: a minimum rate of change of the measurement voltage, a minimum change of the measurement voltage, and an expiration of a time interval; and
ending the measuring of flow velocity or volume flow of the medium and changing to the first operating mode upon meeting at least one of the following criteria: a change of the ascertained flow velocity or volume flow below a minimum value over at least two measurements, and/or performing an established number of measurements.
